(19) United States
(12) Patent Application Publication
(10) Pub. No.: US 2016/0284229 A1
(43) Pub. Date: Sep. 29, 2016

(54) EDUCATIONAL SURF GAME APPARATUS AND METHOD FOR USING SAME

(71) Applicant: HOT GROMMET SURFBOARDS PTY LTD, Freshwater, New South Wales (AU)

(72) Inventor: Timothy HATTON, New South Wales (AU)

(21) Appl. No.: 15/029,971

(22) PCT Filed: Oct. 3, 2014
(86) PCT No.: PCT/AU2014/000957

§ 371 Date: Apr. 15, 2016

(30) Foreign Application Priority Data
Oct. 4, 2013 (AU) 2013903837

(51) Int. Cl. G09B 19/00; A63F 13/00; A63F 3/00

(52) U.S. Cl. CPC G09B 19/00; A63F 3/00006; G09B 19/0092; A63F 13/00; A63F 2003/00018

(57) ABSTRACT

The present invention relates to an educational game and physical and electronic implementations thereof. The board game is played for the purpose of educating the player or players with respect to surf beach safety. The game comprises a start position and an end position and a path defined therebetween. The path is comprised of a plurality of predetermined positions that are associated with a plurality of surf zones including a beach or sand zone, a swim zone and a surf zone. Depending on which predetermined position the player is occupying, the player is presented with a scenario that results in the player advancing or reversing along the path. In some embodiments the player directed to advance or reverse, in others, the player is asked a question and depending on whether they are correct or not, they are directed to advance or retreat along the path. Scenarios include sand scenarios associated with the sand zone, swim scenarios associated with the swim zone, and paddle, soft board and hard fibreglass board scenarios associated with the surf zone. Bonus training cards are collected at points throughout the game and can be used to accelerate the movement of a player's position on the path at specialised positions that when encountered require either a certain number of turns or a precise number to be randomly generated. The game is described in conjunction with dedicated physical apparatus, as well as in respect of an electronic embodiment, suitable for execution on many general computing devices.

### TECHNICAL FIELD

The field of the present invention relates to the art of educational apparatus including board games, electronic gaming apparatus and electronic gaming generally wherein the game of the present invention is concentrated with providing the participant with an understanding of how to safely use a surf beach.

### BACKGROUND ART

With 75% of the Australian population living within two hours drive of the ocean, surf education has become increasingly important. Many beach goers fail to realise that although surf beaches are a beautiful and sometimes tranquil environment, they are, under certain conditions, extremely dangerous and in an instant can become life threatening and destroy a human being and theft families, as has sadly been demonstrated several times every summer. One poor decision can literally mean the difference between life and death.

There are incidents every day when someone, through sheer ignorance, swims in to a dangerous “Rip” or channel and finds themselves washed out to sea and needing rescue. Even the basic things, that regular beach goers take for granted, like swimming between the flags, regularly applying sunscreen, wearing sun protective clothing, staying out of the water if under the effects of drugs or alcohol, wearing loose fitting clothing in the water, being competent to swim in certain conditions, learning to ride a surfboard away from experienced riders, holding their surfboard through breaking waves rather than throwing it away and injuring the people behind them, seem to escape the knowledge of novice beach goers.

It is not only the ocean that can be a ruthless master but there are many incidental threats to well being that the novice surf beach goer needs to be aware of for a safe and secure experience. For example, there have been many incidents of “Surf Rage” in the past, where, but for the lack of knowledge of a few simple rules, usually on the part of the novice, violence has erupted and people have been hurt.

It is an object of the invention to identify aspects of safe surf beach use and incorporate them into a game that can be played by participants and through doing so, are educated with the information necessary to safely use a surf beach, at least, in Australia.

### DISCLOSURE OF THE INVENTION

In a first aspect of the invention there is provided apparatus comprising:
random number generator;
a playing surface bearing:
   a background with a plurality of surf beach zones;
   a start position and an end position and a path connecting them that passes through the plurality of surf beach zones;
   predetermined positions on the path;
player tokens or indicia;
scenario cards associated with the plurality of surf beach zones and wherein the scenarios contained on the cards relates to uses of the plurality of surf beach zones and are either generally positive and result in the player or players advancing themselves along the path, or generally negative and result in the players reversing their position along the path; and

wherein a player uses the random number generator to generate a number which the player then advances their token or player indicial by the number of predetermined positions generated, the player then being presented the content of a scenario card associated with the predetermined position landed on, and then either moving forward along the path or reversing along the path as directed by the scenario card and repeating the process until a player reaches the end point and is declared the winner of the game or provided a score for the performance of the player during the game.

Preferably there are specialised positions located on the path at the transition, at least, from one surf zone to another in which players are required to spend time (turns) or generate specific numbers via the random number generator before they can progress to the next set of predetermined positions in the next surf zone.

More preferably, the apparatus further comprises training bonus cards which are accumulated by players after each turn in a specialised position in which they must remain for a given number of turns, or after being presented a scenario card with generally positive content, wherein the training bonus cards are retained by the player or players to return in order to speed theft advance through the specialised positions that require specific numbers to be generated.

Still more preferably the specialised positions comprise a swimming pool in which the players are required to spend a certain number of turns before heading into the swim zone and/or waiting positions located in the surf zone which require a player to (i) generate a number that results in the players token or indicia landing on the waiting position precisely and/or requires the payer to generate exactly a precise number in order to advance along the path, and wherein the players that generate numbers insufficient to reach the waiting position or insufficient to proceed from the waiting position can surrender training bonus cards to make up the difference to the precise numbers required.

In one embodiment, the surf zones comprise a sand zone, a swim zone and a surf zone. With respect to the predetermined positions there are preferably sand positions associated with the sand zone, swimming positions associated with the swim zone, and paddle, soft board and fibreglass positions associated with the surf zone. It is preferred that there are a corresponding set of scenario cards associated with the sand positions/sand zone, a set associated with swimming positions/swim zone, and a set associated with paddle and soft boards positions/surf zone, and a further set associated with fibreglass board positions/surf zone.

According to a second aspect of the invention there is provided a method of for playing an electronic implementation of the educational surf game of the first aspect of the invention in which the apparatus that the game is played on has:
memory for storing the software for executing the game in the apparatus;
processor for processing the software;
input means for receiving input from one or more players;
display means for displaying the simulated playing surface;
optionally, networking or communication means for connecting the apparatus to other similar apparatus so that players can play against each other or in connection with a leaderboard or scoreboard;

and wherein the apparatus is adapted to provide to the user of the apparatus:
random number generator;
a simulated playing surface bearing:
   a background with a plurality of surf beach zones;
   a start position and an end position and a path connecting them that passes through the plurality of surf beach zones;
   predetermined positions on the path;
indicia of the players position;
virtual scenario cards associated with the plurality of surf beach zones; and

generating a random number;

using the random number generated to advance the players indicia by the number of predetermined positions generated;

presenting a scenario associated with the predetermined position indicated by the indicia;

moving the players indicia either forward along the path or reversing along the path;

repeating the steps of generating random numbers and moving the players indicia until the player reaches the end point and is declared the winner of the game or provided a score for the performance of the player during the game.

Preferably the scenarios relate to uses of the plurality of surf beach zones and are either
generally positive and result in the player or players advancing themselves along the path, or generally negative and result in the players reversing their position along the path; or
are accompanied by a question which if answered correctly via the input means results in the player's indicia moving forward along the path or if answered incorrectly, results in the players reversing their position along the path.

Preferably mini-games are provided for the player to complete at specialised positions located on the path at the transition, at least, from one surf zone to another which simulate aspects of the surf zone and which are required to be completed before advancing along the path.

### BRIEF DESCRIPTION OF THE DRAWINGS

In order that the invention may be readily understood and put into practical effect, reference will now be made to the accompanying drawings, in which:

FIG. 1 is a top plan view of a playing surface of a board game according to a first aspect of the invention;

FIG. 2 depicts a selection of sand zone cards with the top row being those that set out a generally negative scenario and the bottom row a generally positive scenario;

FIG. 3 depicts a selection of swimming zone cards with the top row being those that set out a generally negative scenario and the bottom row a generally positive scenario;

FIG. 4 depicts a selection of paddle and soft board zone cards with the top row being those that set out a generally positive scenario and the bottom row a generally negative scenario;

FIG. 5 depicts a selection of fibreglass zone cards with the top row being those that set out a generally negative scenario and the bottom row a generally positive scenario;

FIG. 6 depicts a selection of training bonus cards and the tips recorded on them;

FIG. 7 is a top view of a first embodiment of the second aspect of the invention, an electronic tablet and/or smartphone implementation of the board game of the first aspect of the invention;

FIG. 8 is a front view of a second embodiment of the second aspect of the invention, adapted for use on a handheld gaming machine;

FIG. 9 is a front view of a third embodiment of the second aspect of the invention, adapted for use on laptop computers and other general PC's including desktop computers;

FIG. 10 is a front view of a fourth embodiment of the aspect of the invention, adapted for use in console based gaming systems (and/or including smart TVs); and

FIG. 11 is a front view of a fifth embodiment of the second aspect of the invention, adapted for use in in-flight entertainment systems used in aircraft and other similar vehicles.

### MODES FOR CARRYING OUT THE INVENTION

The first aspect of the invention is an apparatus and method for using the same. The method involves playing a game with the apparatus where generally users are provided a plurality beach surf zones and where they need to navigate through the zones by way of exposure to various scenarios and where depending on the scenario will cause theft tokens to either advance their position on the board or cause the player to move back in theft position. In all embodiments of both aspects of the invention there is an end point. In some embodiments where there are more than one player the winner of the game will be the person who reaches the end point first. In other embodiments, a scoring system is provided where participants or players compete against each other by way of comparing scores attained at the time the end point is reached.

In all embodiments, however, the players will have, by exposure to the scenarios, assimilated a wealth of knowledge regarding life experiences at the beach including:
healthy attitudes to eating;
training;
respect for other participants;
basic CPR and first aid skills;
respect for the beach environment and associated flora and fauna;
recognising dangerous ocean conditions;
recognising dangerous creatures;
recognising what to do in life threatening situation;
how to prepare their bodies for the environment they are about to enjoy;
avoiding conflict;
basic surfing and board riding skills and terminology;
what numbers to call in an emergency, and
how to explore and recognise their limitations so as not to endanger themselves or other users of surf beaches.

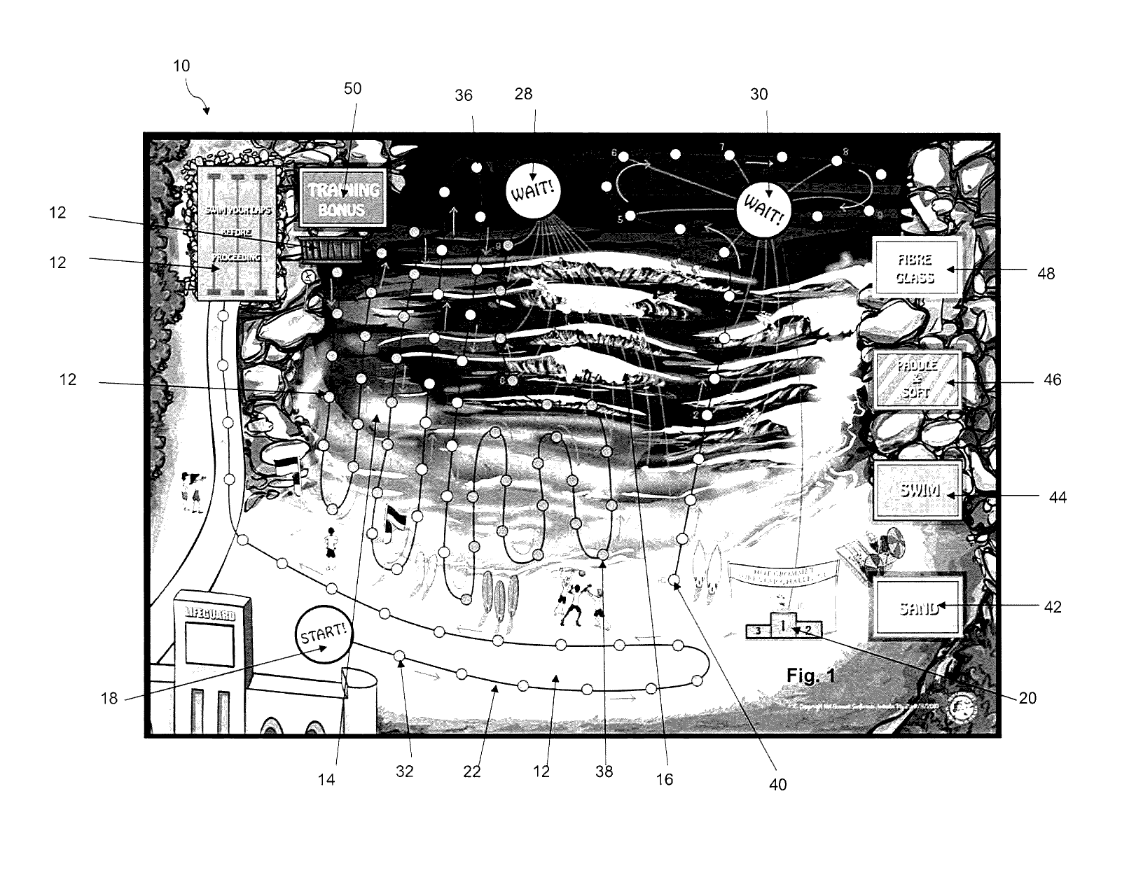

In the first aspect of the invention, the invention comprises physical playing surface which may be provided by way of a traditional board. Referring to FIG. 1 there is depicted the board 10 which has as a background, an illustrated (or it may be a photograph) of a surf beach having a plurality of surf beach zones including at least a sand zone 12, a swim zone 14, and a surf zone 16.

The board 10 also has marked on it a starting position 18 and an end point 20. The starting position 18 and end point 20 define a path 22 upon which further markings or indicia are provided to indicate predetermined game positions. Predetermined game positions fall into a number of categories including:
(i) zoned positions located in one of the aforementioned surf beach zones as set out below; and
(ii) specialised positions including pool 24, jetty 26 and wait zones 28 and 30.

Each of the zoned positions are colour coded and are associated with particular aspects of surf beach use including but not limited to:
(i) sand zoned positions 32 which are found in the sand zone 12,
(ii) swimming zone positions 34 located in the swim zone 14,
(iii) paddle positions 36 in the surf zone 16,
(iv) soft board positions 38 in the surf zone 16; and
(v) fibreglass surfboard positions 40 in the surfzone 16.

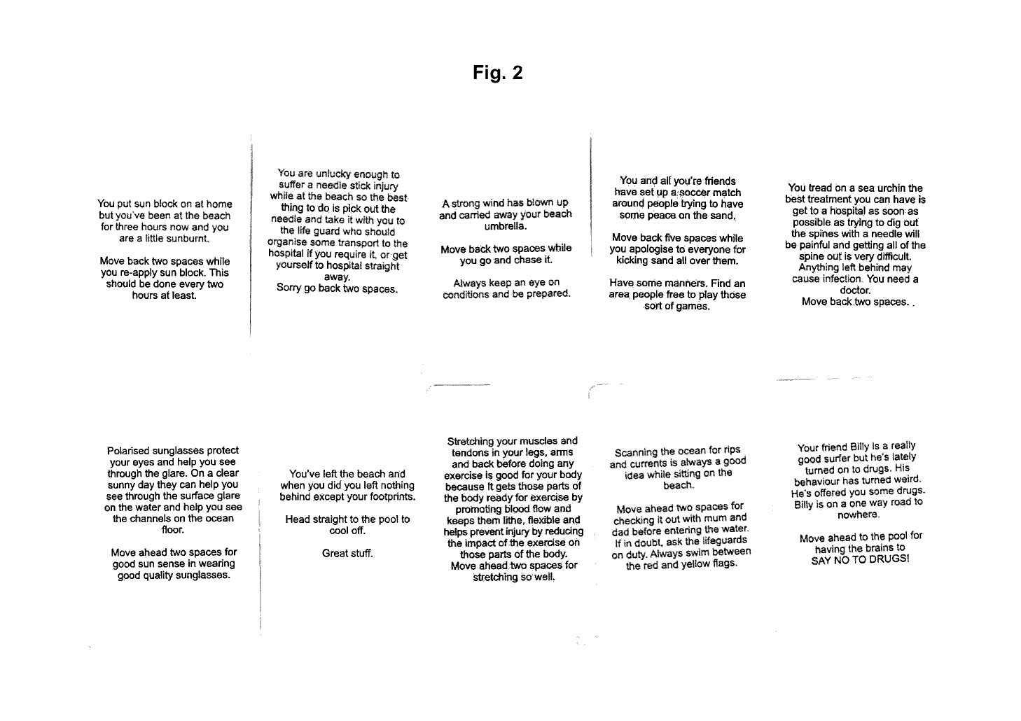

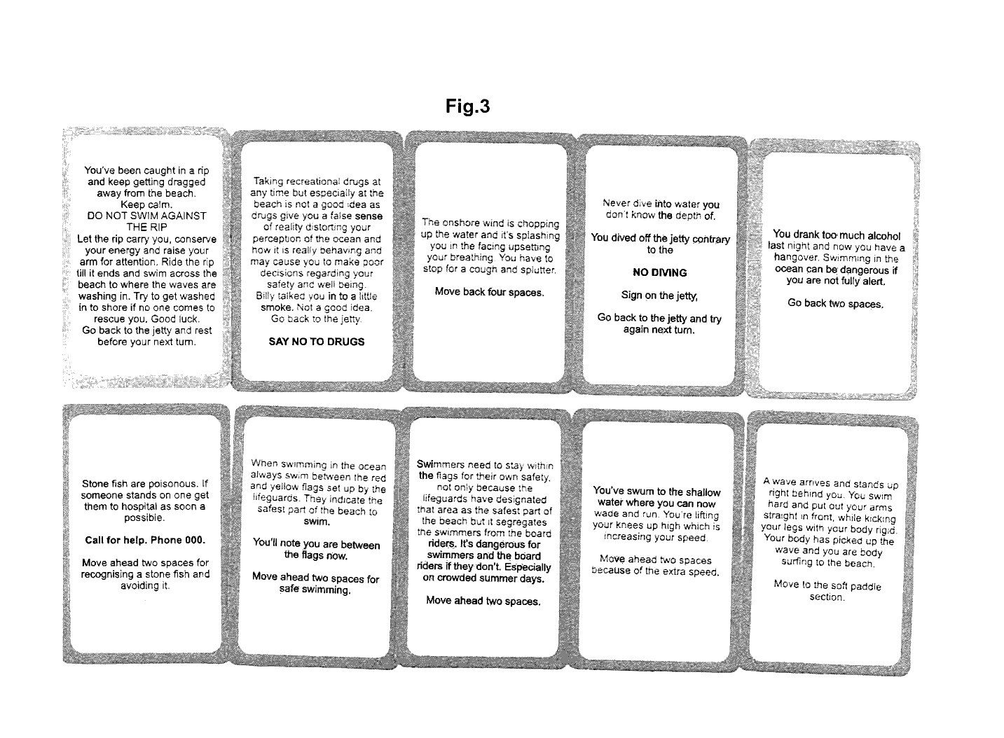

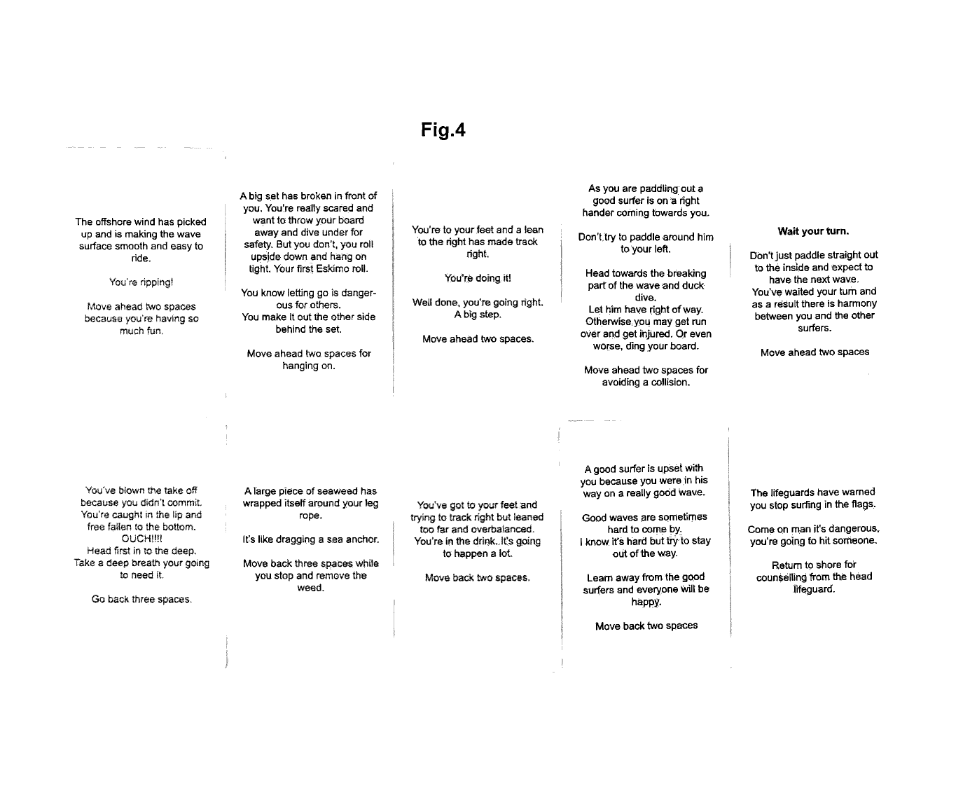

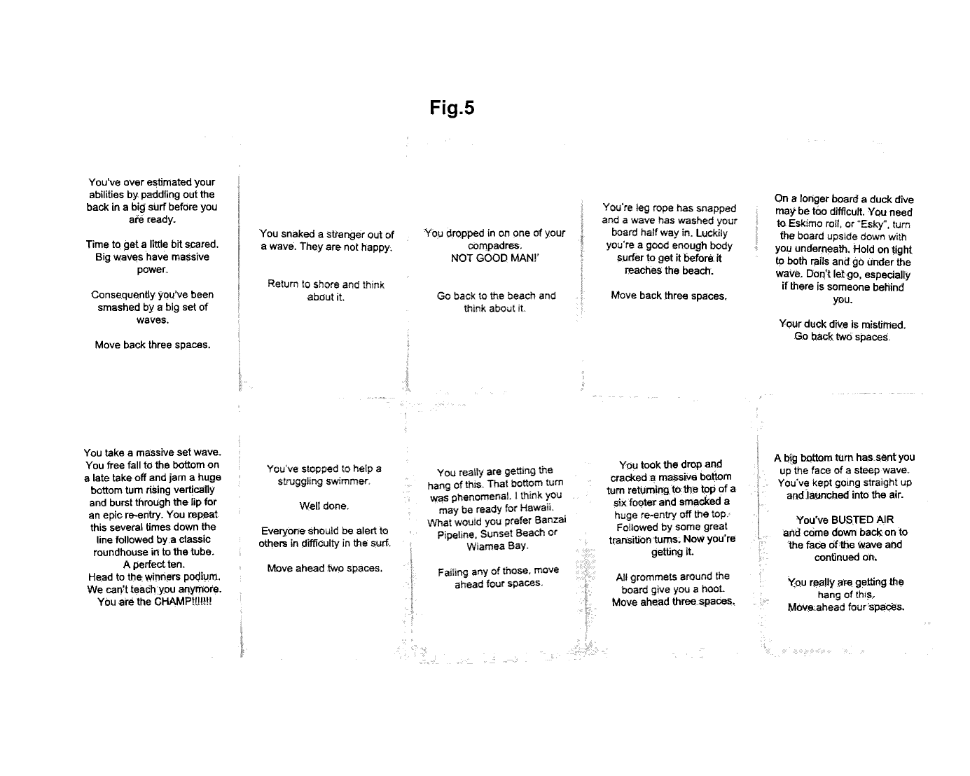

Associated with each type of zoned position are a deck of cards. As depicted in FIG. 1 there are a pile of sand cards 42 which are associated with the sand zoned positions 32, a pile of swim cards 44 associated with swimming zone positions 34, a pile of paddle/soft board cards 46 associated with paddle positions 36 and soft board positions 38 and a pile of fibreglass board cards 48 associated with fibreglass surfboard positions 40. Each of these cards contains a scenario that a novice surfer might actually find themselves at a surf beach. The scenarios are either positive scenarios or negative scenarios, Positive scenarios are those which generally highlight good behaviour or practices or which set out a scenario involving good luck and which reward players by directing them to advance themselves on the path 22 in some way. Negative scenarios set out what is generally poor surf beach behaviour or practices or scenarios of bad luck and which direct the player to move backwards along the path 22. Examples of positive and negative scenarios included in the cards are depicted in FIGS. 2 to 5 where FIG. 2 represents cards from the Sand Zone pile 42, FIG. 3 represents cards from the Swim zone cards 44, FIG. 4 represents cards from the Paddle and soft board cards 46 and FIG. 5 represents cards from the fibreglass board cards 48.

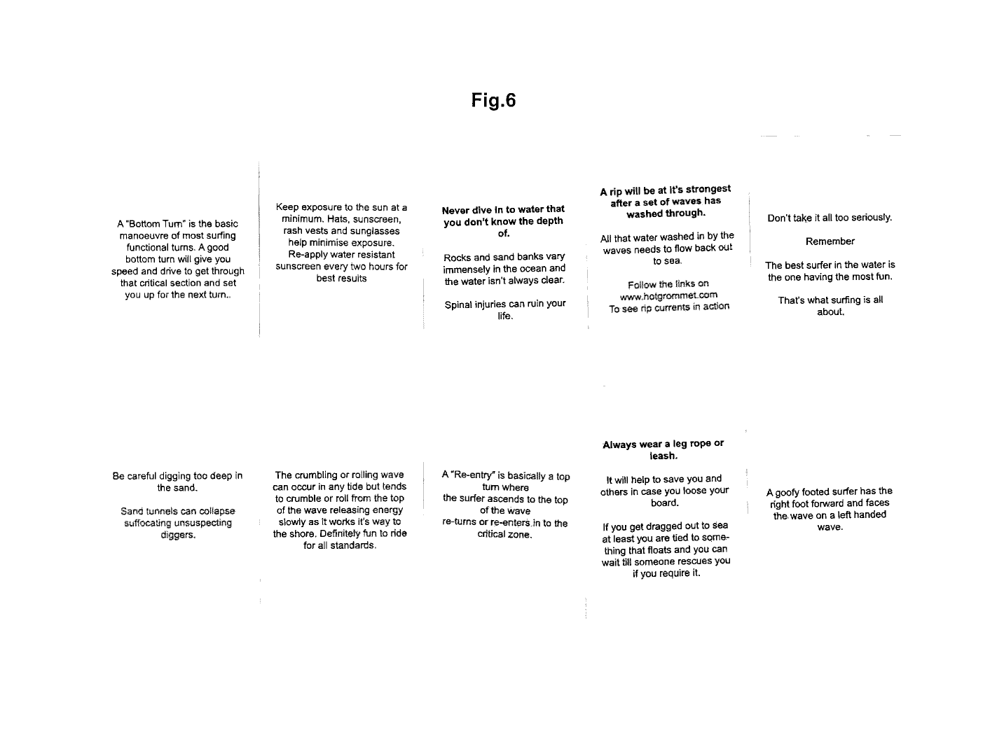

Training bonus cards are provided in training bonus card pile 50 and are provided to players in a variety of situations including upon each turn in the swimming pool 24 or as a result of picking up one of the cards contained in piles 42, 44, 46, and 48 that contains a positive scenario and which indicates that the player is to advance themselves on the path 22. Training bonus cards contain what could be regarded as tips for novice surfers and are to be read aloud before being retained by the player. Examples of training bonus cards are provided in FIG. 6.

In the embodiment depicted in FIG. 1, one or more players advance from the starting position 18 by a number of predetermined game positions as determined by a random number generator. Various types of random number generators may be employed in the present invention including a pair of dice or an electronic random number generator. For present purposes the random number generator comprises a pair of dice allowing a user to roll between 2 and 12.

The game is played by way of each player placing a token or indicia of their position on the start position 18. The first player rolls the dice and advances their token by the number of zoned positions along the path 22. The first move by any payer will result in them landing on a sand zoned position 32 in which case the player picks up a card from the pile of sand cards 42. Once they pick the card up from the pile of sand cards 42 they read it out aloud for the benefit of the other players and either advance or reverse their token along path 22 in the manner instructed by the card.

The first specialised position encountered is the swimming pool 24. If the movement based on what was rolled by the player would result in the player's indicia going beyond the swimming pool 24, the player must stop at the swimming pool 24. If the player lands on or is stopped at the swimming pool 24, the player must remain in the swimming pool for three turns. This is to simulate the importance of being a competent swimmer before entering the ocean. After each turn in the swimming pod the player picks up a training bonus card from the training bonus card pile 50 and keeps it. On the third turn, the player automatically advances to the jetty 24.

Thereafter the player or players advance themselves through the swim zone 14 by stopping at the swimming zone positions 34 along path 22. When landing on a swimming zone position 34 the player picks up a card from the pile of swim zone cards 44 and reads the scenario to the other players and either advances or reverses along path 22 as directed. The same applies to the paddle positions 36 and soft board positions 38. In each case the player does not need to roll any precise number to advance onto the next type of position and associated cards.

With respect to the wait positions 28 and 30 a player must roil the exact number that when advanced on the path 22, would result in the player landing on the wait positions 28 or 30. If the player generates a number that would see the player and on a point beyond the wait position, the player is to move forward to the wait position and then in effect, turn around on the spot and continue in reverse (where the wait position 28 is counted as a position for the purposes of counting the number of steps backwards are required).

Once the player has rolled the precise number required to and on a wait position 28 or 30, on their next turn, from the wait position, the player must roll a 10 to advance theft position. In the case of the first wait position 28, to advance to the fibreglass surfboard positions 40 or in the case of the second wait position 30 to advance to the end point 20. If the player rolls either 11 or 12, the payer forfeits their turn. If the player rolls between 2 and 9, the player follows the alternative pathways set out on the board to positions leading up to the waft position. For instance, if a player rolls a 9, the pathway indicated for the number 9 takes the player one position backwards of the wait position. If a player rolls a 2, they are advanced 8 positions backwards of the wait position.

Bonus cards 22 can be used to help a player advance more quickly through wait position's 28 and 30. In particular, they can be used to make up numbers. For instance, if the player threw or generated the number 7, three retained bonus cards could be surrendered to allow the player to proceed from the wait zones 28 notwithstanding a 10 was not thrown or generated. In the case of the wait zone 30 which precedes the end position 20, three cards must be used to make up one number. For example if a 7 were thrown, 9 training bonus cards would need to be used to make up the number 3 which is added to 7 to achieve the perfect 10 score which allows the player to advance to the end point 20.

Training bonus cards from training bonus card pile 50 can also be used to pay penalties rather than retreating as directed by the cards contained in piles 42, 44, 46, and 48 that contain a generally negative message and direct the payer to retreat by a given number of positions. In some circumstances a card may direct a player to return to a specific position (usually the shore or beach but in the case of the swimming zone positions 34, the jetty 24). In such cases training bonus cards cannot be used to stop the player from being directed to return to the directed position. When directed to the shore or the beach, the payer must return their token to the first position of either the paddle positions 36, soft board positions 38 or fibreglass positions 40 that is nearest the beach.

The educational aspect of the invention is delivered through the content contained on the cards contained in piles 42, 44, 46, 48 and 50, as well as by the positive and negative reinforcement provided by the very structure nature of the game play (set backs and advances, concepts of training and bonuses etc).

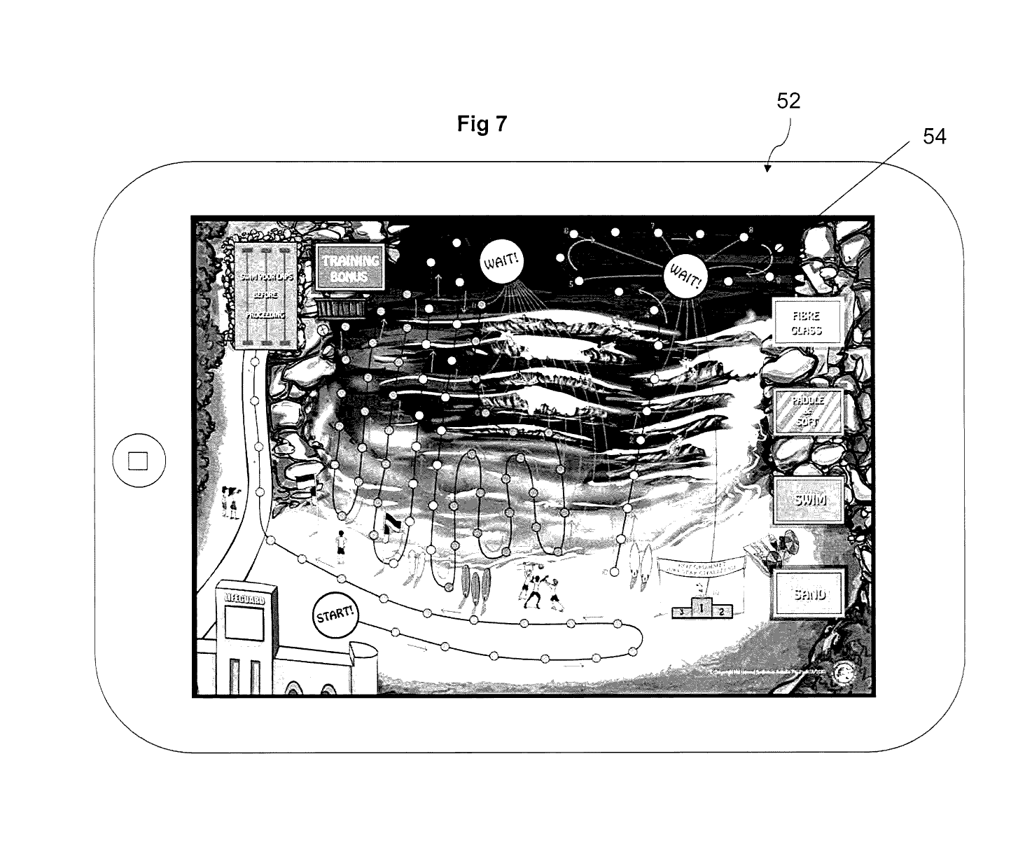

Referring to FIG. 7 there is depicted a first embodiment of the second aspect of the invention which is an implementation of the game in an electronic apparatus which has:
memory for storing the software for executing the game in the apparatus;
processor for processing the instructions contained in the software;
input means for receiving input from one or more players;
display means for displaying the simulated playing surface;
optionally, networking or communication means for connecting the apparatus to other similar apparatus so that players can play against each other, or in connection with a leaderboard or scoreboard.

Specifically, with respect to the first embodiment of the second aspect of the invention, it is adapted for incorporation into the memory of a smartphone or tablet such as Apple Inc's iPad. Such devices 52 comprise a touch sensitive display 54 which is used to output the game graphics as well as receive input from a user. The device 52 would also generally include one or more accelerometers which determine the motion of the device which could also be used as a method of interacting with the device 52 including shaking the device or spinning a simulated wheel or interacting with simulated dice to generate a random number. In the present aspect of the invention, players may play alone against the device 52 and at the finish of the game, may be provided with a score which may be tallied against others scores in the game, including by way of a network connection including the internet. Alternatively players may play together on the one device in turn, or on two networked or connected devices where the game proceeds simultaneously (or incrementally as players come onto the network).

Game play could also be modified by virtue of the fact that such devices may be networked to the Internet in which case new content could be served to the device whereby the cards and their contents could be updated on a regular basis. Further, rather than simply be presented with content that is on the cards shown in FIGS. 2 to 5 and directed to go forwards or backwards, in the present embodiment, in order to make the game more engaging, users of the device may be asked to answer questions, either by way of multiple choice answers or yes/no answers, or by inputting answers to the questions via the simulated keyboard. If a wrong answer is provided the user will be taken backwards and if correct, they will advance forwards. An increased level of engagement would be particularly advantageous if the user is playing the game on their.

In the second aspect of the invention, it is also possible to simulate many of the scenarios that are contained on the cards depicted in FIGS. 2 to 5. The visual simulation would provide reinforcement and learning advantages over the verbal description of them.

In the second aspect of the invention there would also be dexterity based challenges that could take the place of the wait zones of the first aspect of the invention. Mini-games could be incorporated at the junctions between the various zones and position types. For example, there could be a mini-game provided for replacement of the three laps in the swimming pool as described with respect to the first aspect of the invention. In this case, the user would tap the screen to actuate simulated swimming strokes. To slow and they would not win, too fast and they would become inefficient and not win. The second mini-game could be incorporated between the swim and paddle positions. The same controls would be available however the user must now contend with the force of waves. The third mini-game could be incorporated between the paddle positions and the soft board positions. In this game an added control would be provided to make the simulate user duck under waves to improve speed. The fourth mini-game could be incorporated between the soft board and the fibreglass positions. In this game the simulated surfer would need to paddle fast enough (via tapping) to catch a wave then perform a swiping gesture to get up on the simulated board. In a fifth mini-game which would be the final game before the ending of the overall game, the standing up onto the board would be the first achievable target, after standing up, the player must perform basic manoeuvres. The players could drag their fingers on the screen to orientate the simulated surfer. Players would be awarded points for doing successful turns at the top and bottom of a wave. Players could also be awarded points for performing a cutback and awarded points for time spent in the tube of a simulated wave. If the player gets enough points to get a perfect “10 out of 10” they will win the overall game.

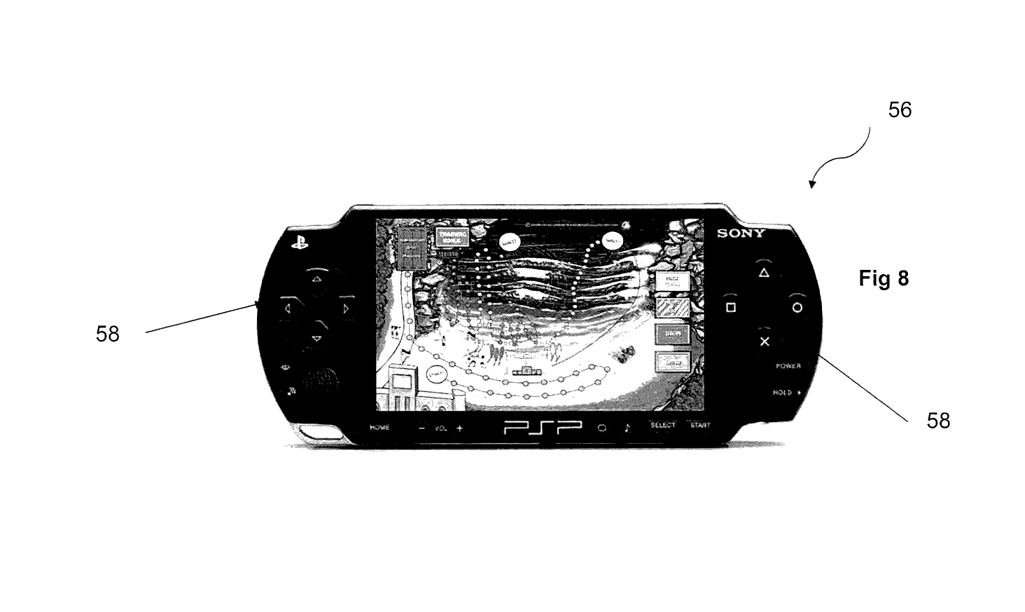

Similar electronic implementations are provided in the second, third, fourth, and fifth embodiments of the second aspect of the invention as depicted in FIGS. 8 to 11 respectively. What differs amongst them are the variety of ways in which the user provides input particularly with respect to the generation of random numbers and providing controls for any mini-games inserted into the electronic embodiments.

In FIG. 8 a handheld gaming console 56 is shown in which the game of the first aspect of the invention is implemented. It differs from the embodiment shown in FIG. 7 as the screen display is not touch sensitive so the player cannot interact directly with the displayed graphics (for instance, in the selection or entering of suitable answers to questions posed). In such a case controls 58 would need to be operated to control the running of the game and the mini-games.

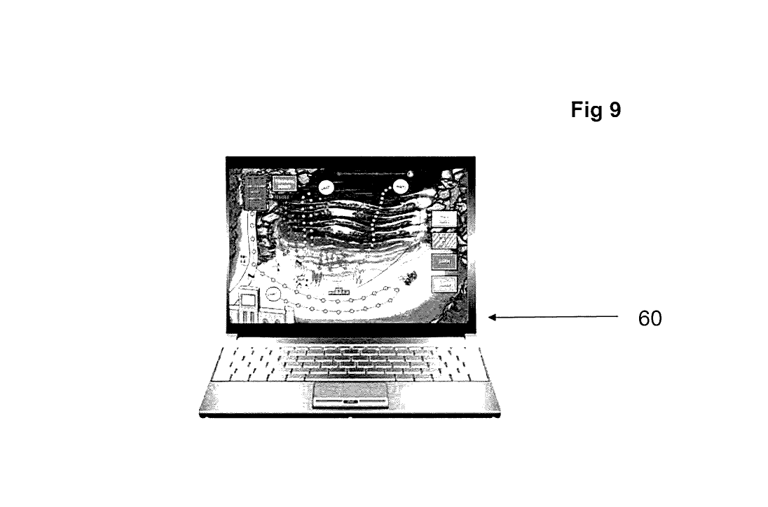

FIG. 9 depicts an embodiment where the software is adapted for installation on a standard laptop or desktop PC 60 whether run locally, or provided online via the internet. Similar comments apply as applied to FIG. 8 in that controls comprising keyboard and mouse/trackpad would be required to play the game and any mini-games incorporated into the game.

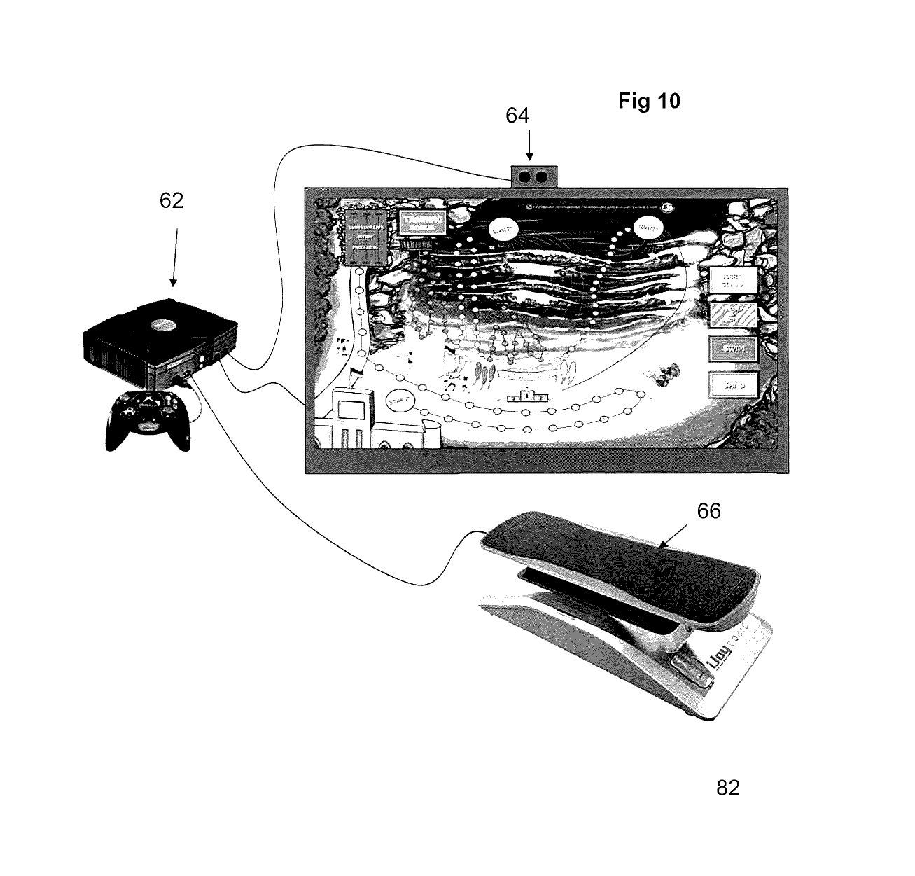

FIG. 10 depicts the game adapted for incorporation and use of a modern gaming console 62. Such consoles provide additional peripherals that can be used. These additional peripherals include motion sensing cameras 64 and balance board 66. The balance board 66 is comprised of motors that adjust the angles of the board as well as pressure sensors in the board 66 that indicate how a person is standing on the board. These additional peripherals would allow the mini-games to be controlled by mimicking the natural movement of a surfer in those mini-games that simulate surfing.

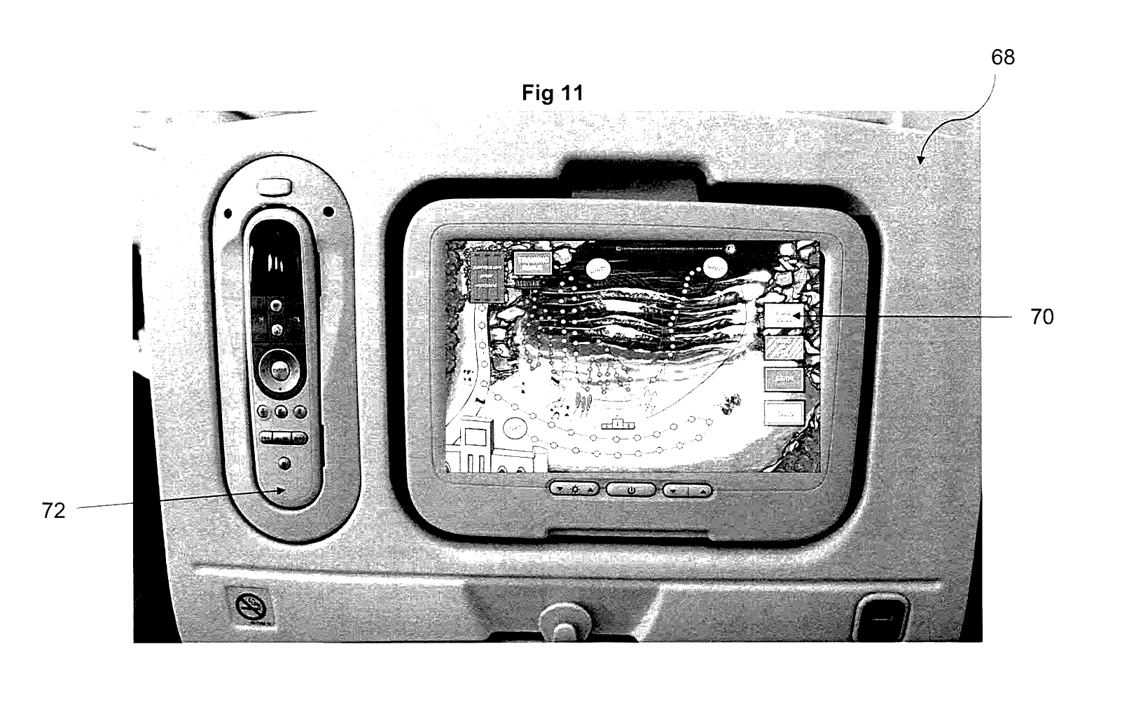

Referring to FIG. 11 is the fifth embodiment of the second aspect of the invention in which there is depicted an aircraft seat 68 in which there is mounted an inflight entertainment system display 70 which has the invention configured for use. In some systems provided by airlines the inflight entertainment system display 68 is a touchscreen display in which case the use and configuration will be much like that of the smartphone or tablet device 52 as described with respect to the second aspect of the invention. Indeed, such inflight entertainment systems are already networked and accordingly, players could play against other passengers or for a score which is tabled on the flight so that players can rank themselves against other passengers. Alternatively, the inflight entertainment system display 68 may not be a touchscreen in which case controls 72 would need to be employed as in the case of the embodiments depicted in FIG. 8 and FIG. 9.

The person skilled in the art will appreciate that the invention is not limited to the embodiments described herein where the invention can be broadly applied and take the form of alternate embodiments.

### INDUSTRIAL APPLICABILITY

The present invention has industrial applicability in the area of gaming, and in particular board games and also electronic games played on a variety of electronic devices.

1. An educational surf game apparatus comprising:
random number generator;
a playing surface bearing:
a background with a plurality of surf beach zones;
a start position and an end position and a path connecting them that passes through the plurality of surf beach zones;
predetermined positions on the path
player tokens or indicia;
scenario cards associated with the plurality of surf beach zones and wherein the scenarios contained on the cards relates to uses of the plurality of surf beach zones and are either generally positive and result in the player or players advancing themselves along the path, or generally negative and result in the players reversing their position along the path; and
wherein a player uses the random number generator to generate a number which the player then advances their token or player indicia by the number of predetermined positions generated, the player then being presented the content of a scenario card associated with the predetermined position landed on, and then either moving forward along the path or reversing along the path as directed by the scenario card and repeating the process until the player or a player reaches the end point and is declared the winner of the game or provided a score for the performance of the player during the game.

2. The educational surf game apparatus of claim 1 wherein there are provided specialised positions located on the path at the transition, at least, from one surf zone to another in which players are required to spend time (turns) or generate specific numbers via the random number generator before they can progress to the next set of predetermined positions in the next surf zone.

3. The educational surf game apparatus of claim 2 wherein the apparatus further comprises training bonus cards which are accumulated by players after each turn in a specialised position in which they must remain for a given number of turns, or after being presented a scenario card with generally positive content, wherein the training bonus cards are retained by the player or players to return in order to speed their advance through the specialised positions that require specific numbers to be generated.

4. The educational surf game apparatus of claim 3 wherein the specialised positions comprise a swimming pool in which the players are required to spend a certain number of turns before heading into the swim zone and/or waiting positions located in the surf zone which require a player to
generate a number that results in the players token or indicia landing on the waiting position precisely; and/or
requires the player to generate exactly a precise number in order to advance along the path;
and wherein the pavers that generate numbers insufficient to reach the limiting position or insufficient to proceed from the waiting position can surrender training bonus cards to make up the difference to the precise numbers required.

5. The educational surf game wherein the surf zones comprise:
a sand zone;
a swim zone and/or;
a surf zone.

6. The educational surf game apparatus of claim 5 wherein predetermined positions comprise:
sand positions associated with the sand zone,
swimming positions associated with the swim zone, and
paddle, soft board and fibreglass positions associated with the surf zone.

7. The educational surf game apparatus of claim 6 wherein a set of scenario cards are associated with the sand positions/sand zone, a set of scenario cards are associated with swimming positions/swim zone, and a set of scenario cards are associated with paddle and soft boards positions/surf zone, and a further set of scenario cards are associated with fibreglass board positions/surf zone.

8. A method of playing an electronic educational surf game the method comprising providing an apparatus that has:
memory for storing the software for executing the game in the apparatus;
processor for processing the software;
input means for receiving input from one or more payers;
display means for displaying the simulated playing surface;
optionally, networking or communication means for connecting the apparatus to other similar apparatus so that players can play against each other or in connection with a leaderboard or scoreboard;
and wherein the apparatus is adapted to provide to the user of the apparatus:
random number generator;
a simulated playing surface bearing:
a background with a plurality of surf beach zones;
a start position and an end position and a path connecting them that passes through the plurality of surf beach zones;
predetermined positions on the path;
indicia of the players position;
virtual scenario cards associated with the plurality of surf beach zones; and
generating a random number;
using the random number generated to advance the players indicia by the number of predetermined positions generated;
presenting a scenario associated with the predetermined position indicated by the indicia;
moving the players indicia either forward along the path or reversing along the path;
repeating the steps of generating random numbers and moving the players indicia until a player reaches the end point and is declared the winner of the game or provided a score for the performance of the player during the game.

9. The method of claim 8 wherein the scenarios relate to uses of the plurality of surf beach zones and are either;
generally positive and result in the player or players advancing themselves along the path, or generally negative and result in the players reversing their position along the path; or
are accompanied by a question which if answered correctly via the input means results in the player's indicia moving forward along the path or if answered incorrectly, results in the players reversing theft position along the path.

10. The method of claim 9 wherein there are provided specialised positions located on the path at the transition, at least, from one surf zone to another in which players are required to spend time (turns) or generate specific numbers via the random number generator before they can progress to the next set of predetermined positions in the next surf zone.

11. The method of claim 9 wherein mini-games are provided for the player to complete at specialised positions located on the path at the transition, at least, from one surf zone to another which simulate aspects of the surf zone that they are and which are required to be completed before advancing along the path.

12. The method of claim 11 wherein the surf zones comprise:
a sand zone,
a swim zone and/or;
a surf zone.

13. The educational game apparatus of claim 12 wherein predetermined positions comprise:
sand positions associated with the sand zone,
swimming positions associated with the swim zone,
and paddle, soft board and fibreglass positions associated with the surf zone.

14. The educational game apparatus of claim 13 wherein a set of scenarios are associated with the sand positions/sand zone, a set of scenarios are associated with swimming positions/swim zone, and a set of scenarios are associated with paddle and soft hoards positions/surf zone, and a further set of scenarios are associated with fibreglass board positions/surf zone.
